(19) United States
(12) Patent Application Publication
(10) Pub. No.: US 2025/0227045 A1
(43) Pub. Date: Jul. 10, 2025

(54) LOW LATENCY AND DETERMINISTIC NODE FAILURE DETECTION

(71) Applicant: Intel Corporation, Santa Clara, CA (US)

(72) Inventors: Yi Wang, Shanghai (CN); Bin Yang, Shanghai (CN); Yu Zhang, Bejing (CN); Patrick Connor, Beaverton, OR (US)

(73) Assignee: Intel Corporation, Santa Clara, CA (US)

(21) Appl. No.: 18/853,476

(22) PCT Filed: May 25, 2022
(86) PCT No.: PCT/CN2022/094861

§ 371 Date: Oct. 2, 2024

(51) Int. Cl. H04L 43/0817; H04L 43/0864; H04L 43/106

(52) U.S. Cl. CPC H04L 43/0817; H04L 43/0864; H04L 43/106

(57) ABSTRACT

Embodiments described herein are generally directed to a flexible mechanism for performing low latency and deterministic node failure detection. In an example, an agent, running on a monitor node of a distributed system, receives from a process, running within a user space of an operating system (OS) of the monitor node, a request to send a probe to a monitored node of the distributed system. The agent is interposed between a networking stack of a kernel of the OS and a transmission media coupling the nodes in communication. The agent causes the probe to be transmitted to the monitored node via the transmission media at a time specified by the request utilizing a time-based packet scheduling feature of a network interface associated with the monitor node. When a time period elapses prior to receipt of a response to the probe, the agent notifies the process of a failure relating to the monitored node.

### TECHNICAL FIELD

Embodiments described herein generally relate to the field of distributed systems and node and/or application monitoring. More particularly, embodiments relate to the use of a fast and deterministic node failure detection solution that leverages a time-based packet scheduling feature of network interfaces of the nodes and locates the module responsible for sending probe and response packets as close to the transmission media interconnecting the nodes as possible, thereby providing low latency and allowing operating system scheduling to be avoided.

### BACKGROUND

In the context of distributed systems, a “heartbeat” is a type of communication packet that is sent between nodes of the distributed system. Heartbeats may be sent at a regular interval and may be used to monitor the availability and/or health of the nodes, networks, and network interfaces, and to prevent cluster partitioning. Heartbeats are commonly used in accordance with a one-way scheme in which a “heartbeat” packet or message is sent by all members of a cluster to all other members of the cluster. Alternatively, heartbeats may be originated by a subset of the members (senders) of a cluster and directed to a central controller (receiver) of the cluster to allow the receiver to determine whether one of the members of the cluster has failed. For example, a source program or application running in a user space of an operating system (OS) of a first node of the cluster may periodically transmit a heartbeat to a target program or application running in a user space of an OS of a second node of the cluster.

### BRIEF DESCRIPTION OF THE DRAWINGS

Embodiments described here are illustrated by way of example, and not by way of limitation, in the figures of the accompanying drawings in which like reference numerals refer to similar elements.

FIG. 1 is a block diagram illustrating the use of heartbeat (HB) agents in a data center according to some embodiments.

FIG. 2 is a block diagram illustrating interactions among various components of nodes of a distributed system in connection with probe and response packet processing according to some embodiments.

FIG. 3A is a block diagram of a node according to a first embodiment.

FIG. 3B is a block diagram of a node according to a second embodiment.

FIG. 4A is a flow diagram illustrating operations for performing monitor node HB agent processing according to some embodiments.

FIG. 4B is a flow diagram illustrating operations for performing monitored node HB agent processing according to some embodiments.

FIG. 5A is a timeline illustrating various events and corresponding times relating to probe and response processing according to some embodiments.

FIG. 5B is a timeline illustrating various events and corresponding times relating to probe and response processing according to alternative embodiments.

FIG. 6A is a block diagram a frame structure of a probe packet according to some embodiments.

FIG. 6B is a block diagram a frame structure of a probe response packet according to some embodiments.

FIG. 7 is an example of a computer system according to some embodiments.

### DETAILED DESCRIPTION

Embodiments described herein are generally directed to a flexible mechanism for performing low latency and deterministic node failure detection. As noted above, the use of heartbeats is a common solution to monitor the availability of a node in a cluster. Existing heartbeat mechanisms suffer from various disadvantages. For example, although heartbeats are typically sent at a regular interval, the arrival time of the heartbeats may vary greatly as heartbeats rely on OS scheduling performed by the sender and typically traverse the user space and the kernel space of the OS on both the sender and the receiver node. As such, the exchange of heartbeats involves complex processing (e.g., by the networking stack), high overhead (e.g., multiple memory copies of the packet), multiple lock operations, and the like. Due to the inconsistency in arrival times of heartbeats, existing heartbeat mechanisms typically wait for several heartbeat intervals before making the determination that a node for which a heartbeat has not been received has failed. This may delay mitigation efforts, such as failover and/or node replacement, and may impact the performance of real-time applications (e.g., video conferencing applications, online gaming, distributed storage solutions, transaction processing, and the like).

In view of the foregoing, various embodiments described herein seek to provide a low latency and deterministic node failure detection approach involving an active-probe-based solution for monitoring the availability of nodes that avoids the impact of OS scheduling on the transmission of probe and response packets. According to one embodiment, a heartbeat (HB) agent is provided on each node of a distributed system to handle probe and response packets. Ideally, the HB agent is placed within each node at a location as close as practical to the transmission media coupling the nodes in communication. The HB agent may be logically interposed between a networking stack of a kernel of the OS and the transmission media. An HB agent running on a monitor node of a distributed system receives from a process running within a user space of the OS a request to send a probe packet to a second node of the distributed system. Responsive to the request, the HB agent causes the probe packet to be transmitted to the second node via the transmission media at a time specified by the request by utilizing a time-based packet scheduling feature of a network interface associated with the monitor node. Responsive to a time period elapsing prior to receipt of a response packet to the probe packet, the HB agent may notify the process of a failure relating to the second node. Because host OS scheduling is avoided and therefore has no impact on probe and response packet transmission, the round-trip time (RTT), measuring the time from the transmission of the probe packet from the primary node to the time at which the probe response from the second node is received at the primary node, is both short and stable. The consistency of round-trip time (RTT) allows for a tighter delta beyond which a failure may be more reliably assumed. In this manner, a deterministic node failure detection solution may be provided without the need to wait for several heartbeat intervals to account for potential deviation between scheduled probe and/or probe response transmission times and actual transmission times.

As described further below, in some embodiments, the HB agent may run within a kernel framework (e.g., Linux eXpress Data Path (XDP)) that provides a programmable network data path in the kernel that facilitates attachment of the HB agent to the network interface. For example, the HB agent may be attached as a hook point in a driver of the network interface prior to the point at which ingress packets are copied to the networking stack. Alternatively, the HB agent may run within a smartNIC of the node at issue placing the HB agent even closer to the transmission media.

In the following description, numerous specific details are set forth in order to provide a thorough understanding of example embodiments. It will be apparent, however, to one skilled in the art that embodiments described herein may be practiced without some of these specific details.

### Terminology

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

If it is said that an element “A” is coupled to or with element “B,” element A may be directly coupled to element B or be indirectly coupled through, for example, element C. When the specification or claims state that a component, feature, structure, process, or characteristic A “causes” a component, feature, structure, process, or characteristic B, it means that “A” is at least a partial cause of “B” but that there may also be at least one other component, feature, structure, process, or characteristic that assists in causing “B.”

An “embodiment” is intended to refer to an implementation or example. Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. It should be appreciated that in the foregoing description of exemplary embodiments, various features are sometimes grouped together in a single embodiment, figure, or description thereof for the purpose of streamlining the disclosure and aiding in the understanding of one or more of the various novel aspects. This method of disclosure, however, is not to be interpreted as reflecting an intention that the claimed embodiments requires more features than are expressly recited in each claim. Rather, as the following claims reflect, novel aspects lie in less than all features of a single foregoing disclosed embodiment. Thus, the claims are hereby expressly incorporated into this description, with each claim standing on its own as a separate embodiment.

As used herein a “distributed system” generally refers to a system with multiple components located on different nodes that communicate and coordinate actions in order to appear as a single coherent system to an end-user or a client of the distributed system. The nodes that are part of a distributed system may be computers, physical servers, virtual machines, or containers. Non-limiting examples of distributed systems include a cluster of a container management system (e.g., a Kubernetes cluster or an OpenStack cluster) and a distributed key-value store (e.g., etcd).

As used herein a “monitor node” generally refers to a node of a distributed system that monitors one or more aspects (e.g., availability and/or health) of another node (a “monitored node”) of the distributed system. In some situations, the monitor node may perform one or more management functions on behalf of the distributed system or may involve management of the monitored nodes of the distributed system. In the context of Kubernetes, a primary node or a control plane node of a cluster is an example of a monitor node and the worker nodes of the cluster represent the monitored nodes of the distributed system. In the context of etcd, the follows may represent examples of monitor nodes and the leader may represent an example of a monitored node.

As used herein a “network interface” generally refers to a point of interconnection between a computer and a private or a public network. A network interface may be implemented in physical form and/or implemented in software. Non-limiting examples of a network interface include an Ethernet controller, a network adapter, a network interface controller, a local area network (LAN) adapter, a network interface card (NIC), a smartNIC, or another device to which certain functions may be offloaded and/or accelerated, including an infrastructure processing unit (IPU) and a data processing unit (DPU).

As used herein a “time-based packet scheduling feature” of a network interface generally refers to a feature of the network interface that allows a packet to be submitted to the network interface for transmission at a specified time. A non-limiting example of a time-based packet scheduling feature is the launch time control feature supported by various Intel network adaptors, such as the Intel I210 family of network adapters.

### Example Operating Environment

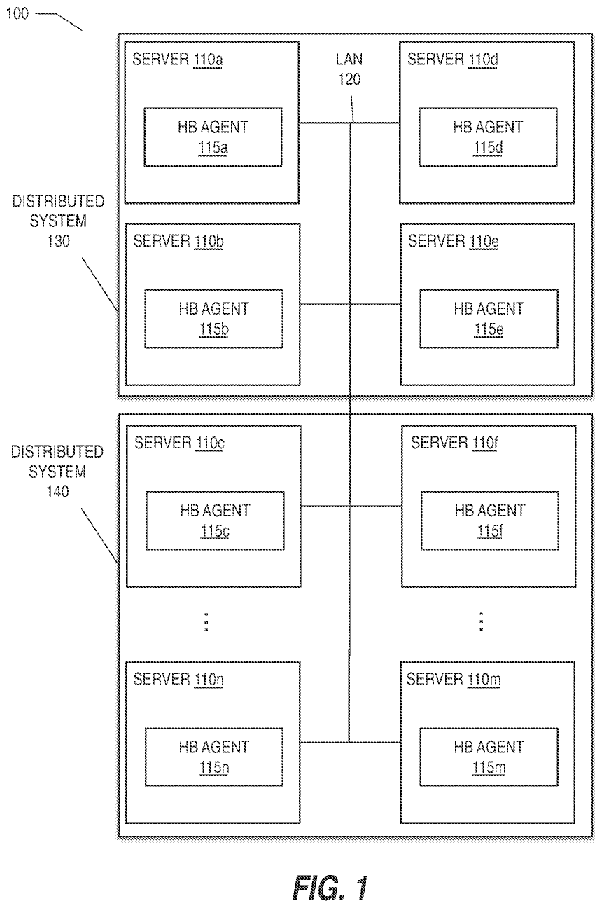

FIG. 1 is a block diagram illustrating the use of heartbeat (HB) agents 115a-n and 115d-m in a data center 100 according to some embodiments. In the context of the present example, the data center 100 includes multiple servers 110a-n and 110d-m coupled in communication through a local area network (LAN) 120 and each running a corresponding HB agent 115a-n and 115d-m. Multiple distributed systems may be represented within the data center 100. For example, a first distributed system 130 may include nodes represented by servers 110a, 110b, 110d, and 110e; and a second distributed system 140 may include nodes represented by servers 110c-n and servers 115f-m).

### Example High-Level Sequence of Events for Probe and Response Packet Exchange

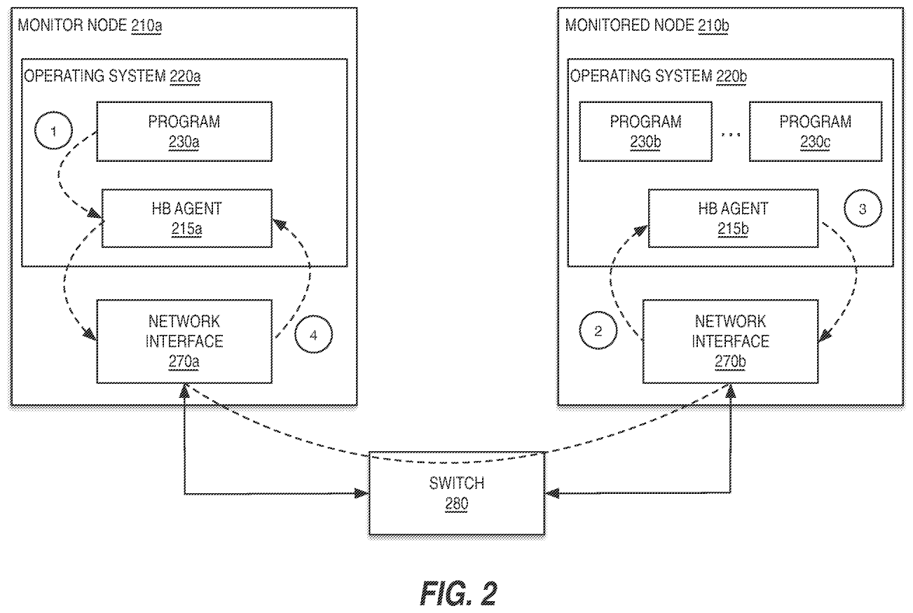

FIG. 2 is a block diagram illustrating interactions among various components of nodes of a distributed system 200 in connection with probe and response packet processing according to some embodiments. While for sake of brevity, in the context of the present example, two nodes (e.g., a monitor node 210a and a monitored node 210b) of the distributed system 200 are shown, it is to be appreciated the distributed system 200 may include additional nodes and the exchange of probe and response packets between the monitor node 210a and such additional nodes may follow the same high-level sequence of events as the exchange of probe and response packets between the monitor node 210a and the monitored node 210b.

While not so limited, distributed system 200 may represent one of distributed systems 130 or 140. In the context of the present example, both the monitor node 210a and the monitored node 210a are shown including respective operating systems (e.g., operating system 220a and operating system 220b) and network interfaces (e.g., network interface 270a and network interface 270b). The operating systems may represent a current or future version of one of the various existing commercial or open-source operating systems. Non-limiting examples of operating systems include Linux distributions, FreeBSD, and the Windows operating system. The network interfaces may implement the electronic circuitry to facilitate communication among host computers on the same LAN) and/or large-scale network communications through routable protocols (e.g., Internet Protocol (IP)) using a specific physical layer and data link layer standard (e.g., Ethernet or Wi-Fi). Non-limiting examples of network interfaces include NICs, smartNICs, and IPUs.

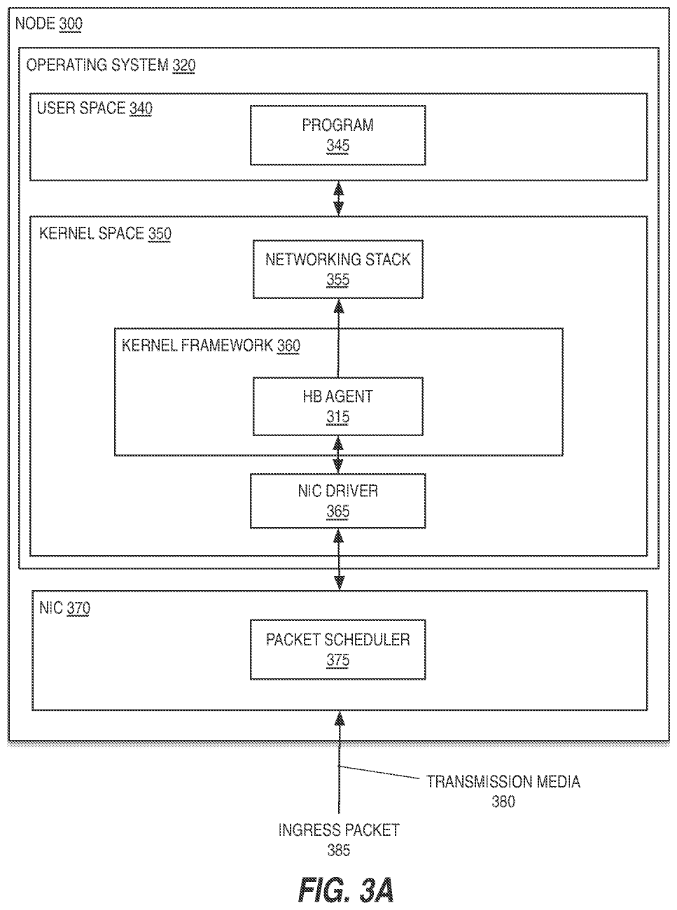

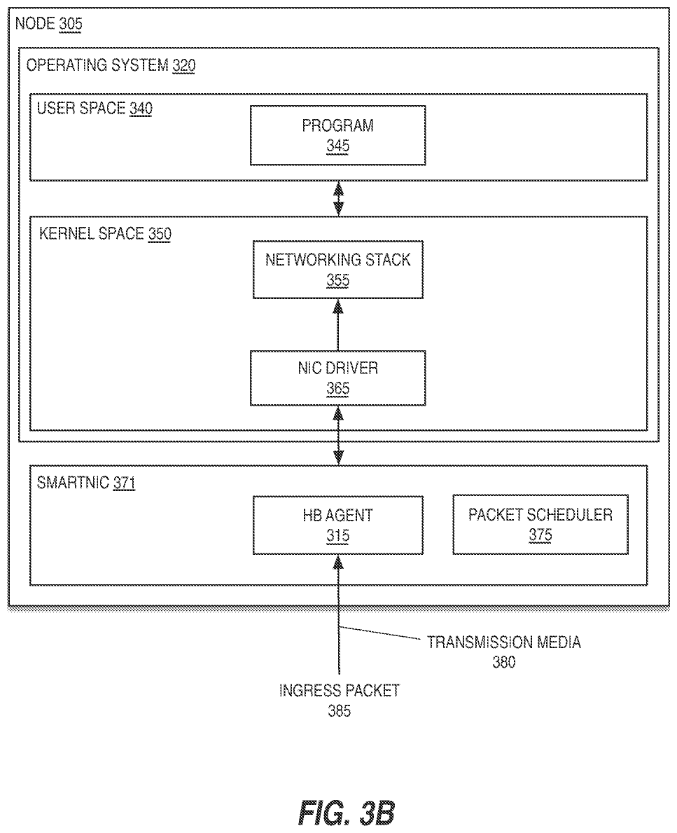

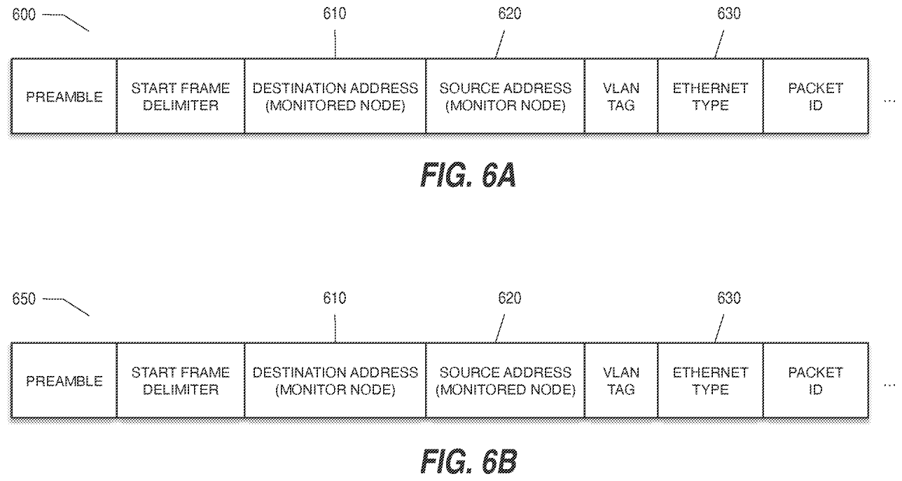

Operating system 220a is shown running a program 230a and an HB agent 215a and operating system 220b is shown running multiple programs 230b-c and an HB agent 215b. In various examples described herein, program 230a (which may represent an orchestrator of cluster of container management system or a leader of a distributed key-value store) may request HB agent 215a to send a probe packet to the monitored node (which may represent a worker node of the cluster or a follower of the distributed key-value store) as indicated by the first hop of dotted line #1. The request may specify a time at which the probe packet is to be transmitted. Responsive to the request, HB agent 215a may create the probe packet and make use of a time-based packet scheduling feature of network interface 270a to cause network interface 270a to transmit the probe packet (the second hop of dotted line #1) to the monitored node 210b. When the monitor node 210a and the monitored node 210b are within different host systems, the probe packet may traverse one or more networking devices (e.g., switch 280) associated with a LAN (e.g., LAN 120). A non-limiting example of a frame structure of a probe packet is described below with reference to FIG. 6A. As noted above, in an effort reduce the latency or RTT and increase the stability of the RTT, the respective HB agents 215a-b are positioned within the nodes 210a-b as close to the network interfaces 270a-b as possible as described further below with reference to FIG. 3.

Returning to the high-level sequence of events, after receipt of the probe packet at network interface 270b, the probe packet may be intercepted by HB agent 215b (as indicated by dotted line #2) to facilitate prompt return of a response packet to the monitor node 210a. Similar to the mechanism for scheduling probe packet transmission, HB agent 215b may create the response packet and make use of a time-based packet scheduling feature of network interface 270b to cause network interface 270b to transmit the response packet (as indicated by dotted line #3) to the monitor node 210b. A non-limiting example of a frame structure of a response packet is described below with reference to FIG. 6B.

After receipt of the response packet at network interface 270a, the response packet may be intercepted by HB agent 215a (as indicated by dotted line #4) to facilitate prompt processing of the response packet.

### Example Node Architectures

FIG. 3A is a block diagram of a node 300 according to a first embodiment. Node 300 represents a more detailed example of the architecture of monitor node 210a or second node 210b. As above, node 300 includes an operating system 320, which may be analogous to operating system 220a and 220b and a network interface 360, which may be analogous to network interface 270a and 270b. The operating system 320 includes a user space 340 and a kernel space 350. The user space 340 represents a memory area in which application software (e.g., program 345) typically executes, whereas the kernel space 350 represents a memory area that is typically reserved for running a privileged operating system kernel, kernel extensions, and most device drivers (e.g., NIC driver 365).

In the context of the present example, kernel space 350 includes a networking stack 355 and a kernel framework 360. The networking stack 355 may implement a set of communication protocol used by the Internet or similar networks collectively referred to as the Internet Protocol (IP) suite, which allows the applications (e.g., program 345) to send and receive communications via a network (e.g., transmission media 380) through a network interface (e.g., NIC 370 in which packet schedule 375 represents the time-based packet scheduling feature). The kernel framework 360 may provide a programmable network data path in the kernel space 350 to facilitate processing of an ingress packet 385 by an HB agent 315 (which may be analogous to HB agents 115 and 215) at the lowest point in the operating system 320 of the node 300—prior to the ingress packet 385 being copied to the network stack 355. A non-limiting example of kernel framework 360 is Linux XDP, in which case the HB agent 315 would represent an XDP program that is attached as a hook point in the NIC driver 365 prior to the point at which the ingress packet 385 would normally be copied to the network stack 355, thereby allowing HB agent 315 to intercept and evaluate the ingress packet 385 before it gets to the network stack 355.

In one embodiment, the HB agent 315 is configurable via a Berkeley Packet Filter (BPF) or an extended BPF that distinguishes between ingress packets (e.g., normal packets) that should be passed through to user space 340 via the networking stack 355 and ingress packets (e.g., probe packets or response packets, as the case may be depending upon the role of the node 300) that are to be handled by the HB agent 315. The BPF may be supplied by program 345. In the context of the present example, the HB agent 315 may be attached to the NIC 370 in a native mode (e.g., Native XDP mode) causing the NIC driver 365 to load the HB agent 315 into the early receive path of the NIC driver 365.

FIG. 3B is a block diagram of a node 305 according to a second embodiment. Node 305 represents a more detailed example of the architecture of monitor node 210a or second node 210b. The differences between the architecture of FIG. 3A and FIG. 3B include NIC 370 versus a smartNIC 371 and the execution of HB agent 315 within kernel space 350 versus within smartNIC 371, respectively. In the context of the present example, the HB agent 315 may be attached to the smartNIC 371 in an offloaded mode (e.g., Offloaded XDP mode), causing the HB agent 315 to be loaded onto the smartNIC 371 itself and executed entirely off of processing resources of the host system. In this manner, HB agent 315 may be brought even closer to the transmission media 380.

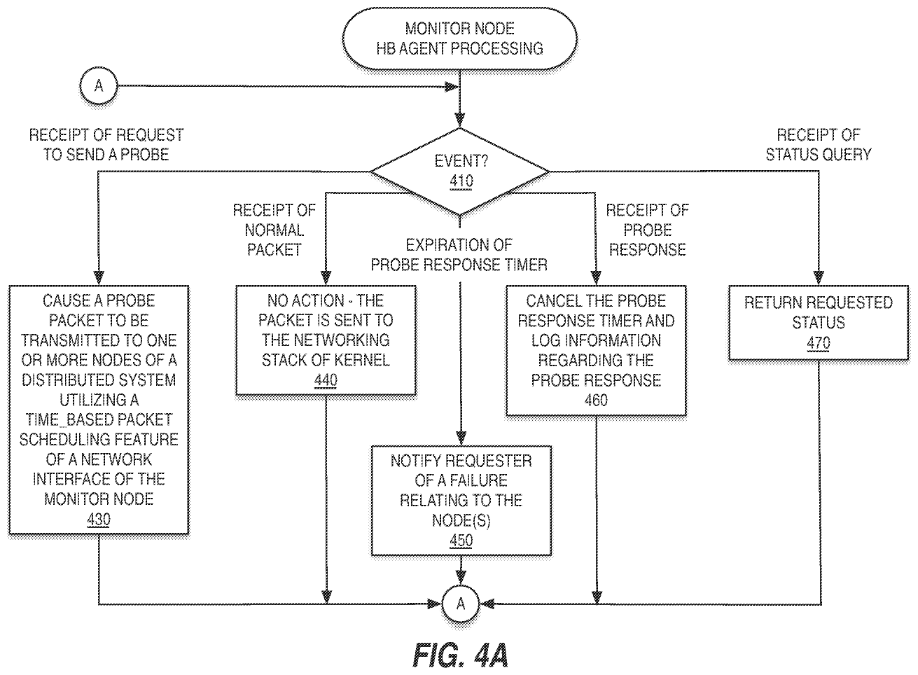

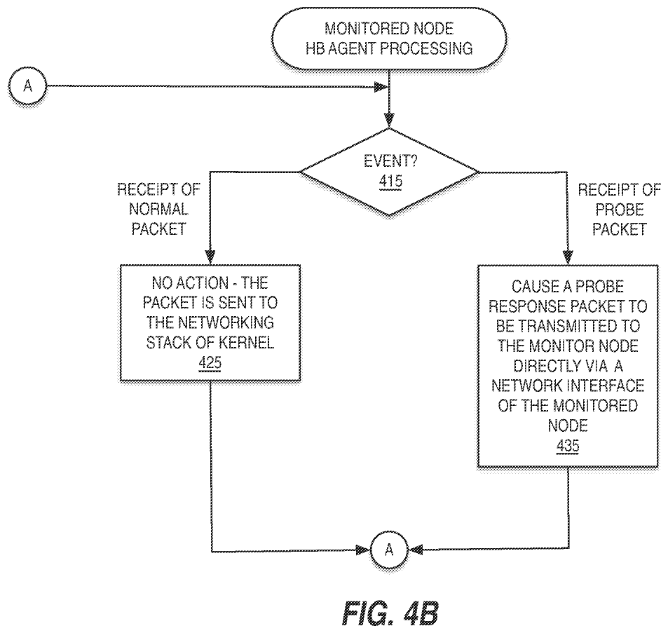

In both of the above example architectures, the HB agent 315 is logically interposed between the networking stack 355 and the transmission media 380, thereby allowing probe and/or response packets as the case may be to be intercepted from ingress network traffic and processed by the HB agent 315 as early as practical. Further details regarding ingress packet processing that may be performed by HB agent 315 depending on the role (e.g., monitor node or monitored node) of the node on which they are operating are provided below with reference to FIGS. 4A and 4B, respectively.

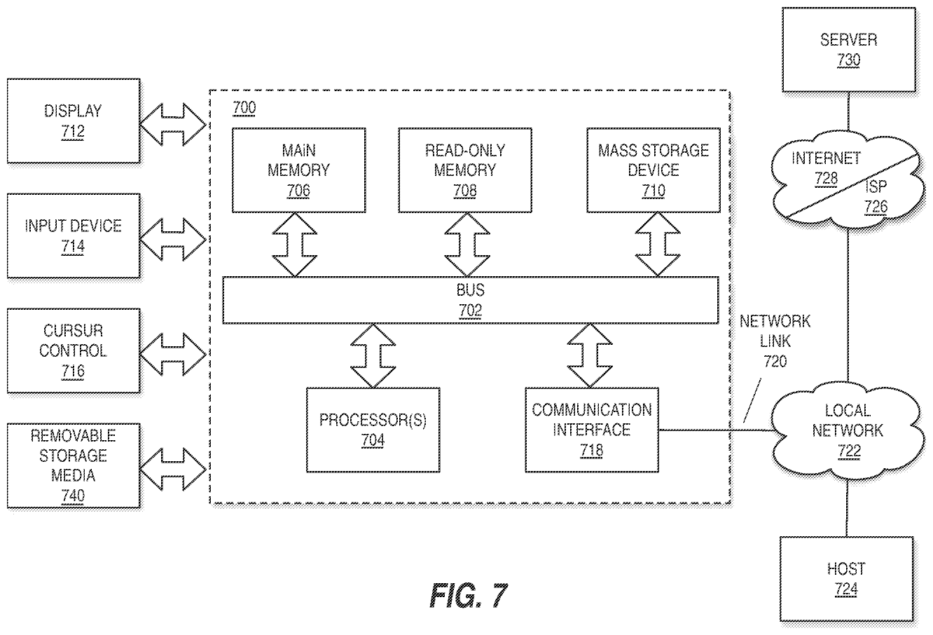

The various functional units of the nodes of FIGS. 3A and 3B (e.g., program 345, networking stack 355, kernel framework 360, HB agent 315, and NIC driver 365) and the processing described below with reference to the flow diagrams of FIGS. 4A and 4B may be implemented in the form of executable instructions stored on a machine readable medium and executed by a processing resource (e.g., a microcontroller, a microprocessor, a CPU core, an ASIC, an FPGA, or the like) and/or in the form of other types of electronic circuitry. For example, the processing may be performed by one or more virtual or physical computer systems of various forms, such as the computer system described below with reference to FIG. 7.

### Example Monitor Node HB Agent Processing

FIG. 4A is a flow diagram illustrating operations for performing monitor node HB agent processing according to some embodiments. The processing described with reference to FIG. 4A may be performed by an HB agent (e.g., HB agent 115, 215a, or 315) deployed within a monitor node (e.g., monitor node 210a) of a distributed system. Depending upon the characteristics of the host system, for example, absence or presence of a smartNIC (e.g., smartNIC 371), the HB agent may be executed within kernel space (e.g., kernel space 360) in a hook of a NIC driver (e.g., NIC driver 365) or within the smartNIC as discussed above with reference to FIGS. 3A and 3B.

At decision block 410, a determination is made regarding the event that initiated the processing at issue for the HB agent. When the event represents receipt of a request to send a probe from a user space process (e.g., program 230a or 345), processing continues with block 430. When the event represents receipt of a normal packet (e.g., a packet other than a probe response packet), processing continues with block 440. When the event represents expiration of a probe response timer, processing continues with block 450. When the event represents receipt of a probe response, processing continues with block 460. When the event represents receipt of a status query from the user space process, processing continues with block 470.

At block 430, the HB agent causes a probe packet to be transmitted to one or more monitored nodes (e.g., monitored node 210b) of the distributed system utilizing a time based packet scheduling feature (e.g., packet scheduler 375) of a network interface (e.g., NIC 370 or smartNIC 371) of the monitor node. As part of the request, the user space process may specify a time at which the probe is to be transmitted from the primary node and provide information indicative of a set of one or more nodes of the distributed system to which the probe is to be transmitted. For example, the user space process may specify the address of a particular monitored node of the distributed system to which the probe is to be transmitted or may indicate the probe is to be broadcast to all monitored nodes of the distributed system. Responsive to receipt of the request, the HB agent may create a probe packet (e.g., in the form described below with reference to FIG. 6A) and schedule the probe packet for transmission by the network interface. As described above, in this manner, the inconsistencies and overhead of OS scheduling and networking stack processing (e.g., within networking stack 355 of kernel space 350) are avoided.

At block 440, an ingress packet that is not of interest to the HB agent (e.g., a normal packet not representing a probe response packet) has been received. In the context of the present example, it is assumed the HB agent processes ingress packets of interest to it, for example, those specified by a BPF or an extended BPF and other ingress packets are left for processing by the NIC driver. For example, the HB agent may be running in a hook of the NIC driver. In such an implementation, no action is taken by the HB agent on ingress packets not representing probe response packets and upon return of control to the NIC driver such packets are sent to the networking stack by the NIC driver.

At block 450, the time period for receipt of a probe response packet to a previously sent probe packet has expired and the requester of the previously sent probe packet may be notified by the HB agent of a failure relating to the node or nodes from which the expected probe response packet has not been timely received. For example, the HB agent may make use of failure detection APIs exposed by an application (e.g., program 230a or 345) or other APIs of the application may be overloaded to inform the application of the issue (e.g., a presumed node failure or a network link failure).

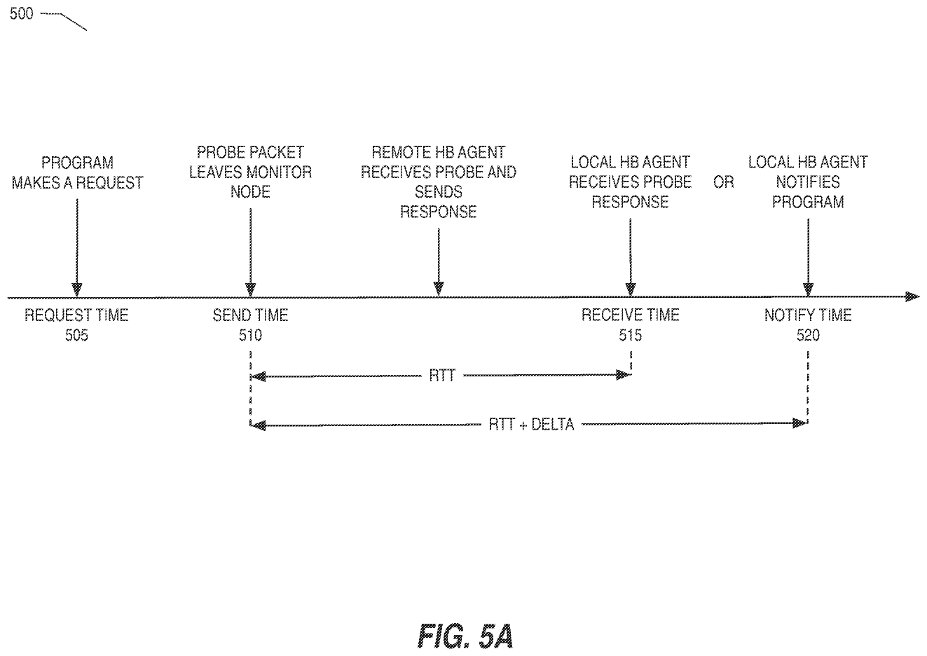

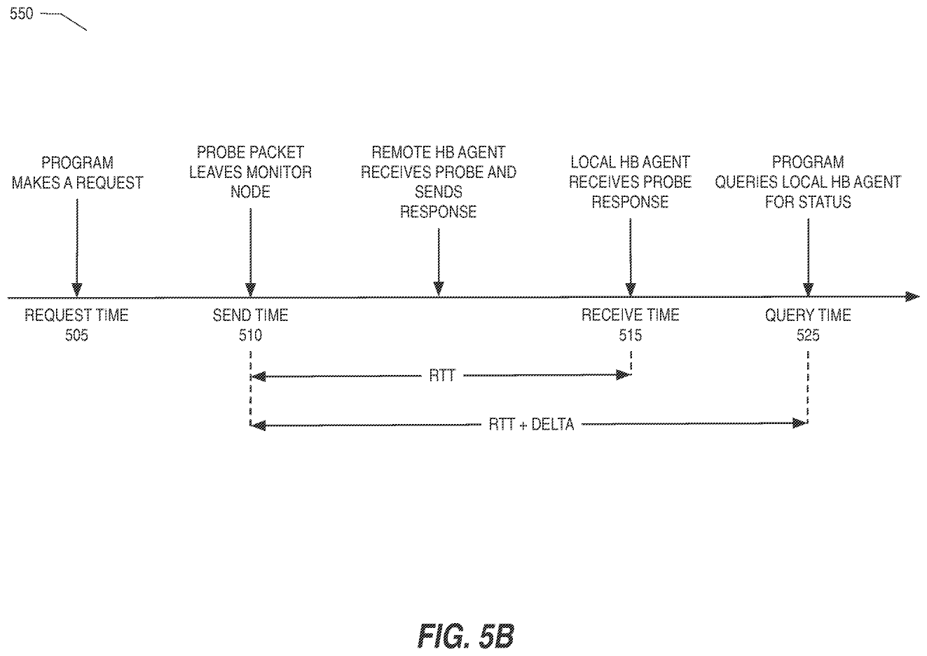

In one embodiment, when the the HB agent schedules a given probe packet for transmission with the network interface at block 430, the HB agent may also set a timer for the time (a notify time) by which the corresponding probe response packet(s) is/are expected to have been received. As noted above and as discussed further below with reference to FIG. 5A, the increased stability in RTT as a result of avoiding use of OS scheduling allows the HB agent to use a relatively tight delta beyond which a failure may be more reliably assumed, thereby facilitating action to be taken more quickly by the requester (e.g., program 230a or program 345) and expediting and improving the operation of the distributed system.

At block 460, responsive to receipt of a probe response packet, the corresponding probe response timer may be cancelled and information may be logged regarding the probe response, including, for example, the time at which the probe response packet was received and any additional information (e.g., node health information/metrics provided within the probe response packet) or derived information (e.g., RTT). In one embodiment, historical information relating to RTT may be used by the HB agent and/or the user space process to update the notification time or a query time, respectively, to adjust for changes in the physical or logical topology of the distributed system.

At block 470, responsive to receipt of a status query from the user space process, the requested status may be returned. Depending upon the particular implementation, such a status query may be used as an alternative to or in addition to the notification of block 450. In this manner, the user space process may have the flexibility to receive push notifications from the HB agent or may poll the HB agent for status information at a desired interval. In one embodiment, information logged in block 460 relating to a particular node or nodes may be returned to the user space process by the HB agent.

While in the context of the present example, probe packets are described as being targeted to a particular monitor node of the distributed system or all monitored nodes of the distributed system, it is to be understood additional information may be included in the probe packet, including to which nodes of the distributed system the probe packet is targeted, one or more microservices/applications on a particular node to which the probe packet is targeted, and/or what information should be included in the probe response packet.

### Example Monitored Node HB Agent Processing

FIG. 4B is a flow diagram illustrating operations for performing monitored node HB agent processing according to some embodiments. The processing described with reference to FIG. 4B may be performed by an HB agent (e.g., HB agent 115, 215b, or 315) deployed within a monitored node (e.g., monitored node 210b) of a distributed system. Depending upon the characteristics of the host system, for example, absence or presence of a smartNIC (e.g., smartNIC 371), the HB agent may be executed within kernel space (e.g., kernel space 360) in a hook of a NIC driver (e.g., NIC driver 365) or within the smartNIC as discussed above with reference to FIGS. 3A and 3B.

At decision block 415, a determination is made regarding the event that initiated the processing at issue for the HB agent. If the event represents receipt of a normal packet (e.g., a packet other than a probe packet), processing continues with block 425; otherwise, if the event represents receipt of a probe packet from a monitor node (e.g., monitor node 210a), processing branches to block 435.

At block 425, an ingress packet that is not of interest to the HB agent (e.g., a normal packet not representing a probe packet) has been received. In the context of the present example, it is assumed the HB agent processes ingress packets of interest to it, for example, those specified by a BPF or an extended BPF and other ingress packets are left for processing by the NIC driver. For example, the HB agent may be running in a hook of the NIC driver. In such an implementation, no action is taken by the HB agent on ingress packets not representing probe packets and upon return of control to the NIC driver such packets are sent to the networking stack by the NIC driver.

At block 435, the HB agent causes a probe response packet to be immediately returned to the monitored node (e.g., monitored node 210b) of the distributed system. Responsive to receipt of the probe packet, the HB agent may create a probe response packet (e.g., in the form described below with reference to FIG. 6B) and schedule the probe packet for immediate transmission by the network interface. As described above, in this manner, the inconsistencies and overhead of OS scheduling and networking stack processing are avoided. Depending upon the particular implementation, it may be helpful for the monitor node to receive additional information (e.g., node health information/metrics) as part of the probe response packet. For example, the probe packet may specify the additional information to be returned. When the probe packet specifies such additional information, the HB agent may retrieve the specified additional information and include it within the probe response packet. Non-limiting examples of such additional information may include resource utilization/load (e.g., processor, memory, and/or storage utilization/load).

While in the context of the flow diagrams presented herein, a number of enumerated blocks are included, it is to be understood that the examples may include additional blocks before, after, and/or in between the enumerated blocks. Similarly, in some examples, one or more of the enumerated blocks may be omitted or performed in a different order.

### Example Event Timelines

FIG. 5A is a timeline 500 illustrating various events and corresponding times relating to probe and response processing according to some embodiments. In the context of the present example, the time at which a program (e.g., program 230a or program 345) associated with a monitor node (e.g., monitor node 210a) makes a request to a local HB agent (e.g., HB agent 215a) to send a probe represents a request time 505. The time at which the probe packet leaves the monitor mode is referred to as a send time 510. The time at which the local HB agent receives the probe response packet corresponding to the probe packet is referred to as a receive time 515. The time elapsed between the send time 510 and the receive time 515 represents the RTT.

In one embodiment, if no probe response packet is received for a particular probe packet within an adjustable time period based on the send time 510 and referred to as a notify time 520, the local HB agent may notify the program regarding a failure associated with the particular node or nodes targeted by the probe packet. The adjustable timer period may be established by adding a predetermined or configurable delta to an average or mean RTT value observed over a particular time window or an average or mean RTT value observed during an initial sampling period performed at startup by the local HB agent.

Because OS scheduling is not used for scheduling the transmission of probe packets and the probe packets need not traverse the networking stack (e.g., networking stack 355) due to the proximity of the HB agent to the transmission media, the RTT is expected to be stable. In one embodiment, for a particular physical and logical topology of a distributed system, the standard deviation (the dispersion of observed RTT values over time from the mean) is expected to be less than 1. Given the RTT stability, the delta value used to establish the notify time 520 may be 10% or less of the RTT, representing a large time savings as compared to prior approaches that must wait multiple heartbeat intervals to be sufficiently confident of a failure.

FIG. 5B is a timeline 550 illustrating various events and corresponding times relating to probe and response processing according to alternative embodiments. In this example, it is assumed no notifications are desired to be received by the program and instead the program will query the local HB agent for status on a periodic basis or on an as needed basis at or after a query time established based on the RTT and the predetermined or configurable delta.

### Example Frame Structures of Probe and Response Packets

FIG. 6A is a block diagram a frame structure 600 of a probe packet according to some embodiments. In the context of the present example, the frame structure 600 represents an Ethernet frame including, among other fields, a destination address 610, a source address 620, and an EtherType (e.g., Ethernet type 630). In one embodiment, the destination address 610 of a given probe packet is the destination IP address of the node to be probed or a broadcast address on which all nodes of a distributed system listen and the source address is the source IP address of the monitor node (e.g., monitor node 210a). In one embodiment, the Ethernet type 630 may be used to distinguish among various types of packets (e.g., probe packets, probe response packets, and other packets, which may be referred to herein as “normal packets”). In this manner, creation of BPF maps to configure the HB agents (e.g., HB agents 115, 215, or 315) is relatively simple and the performance of ingress packet filtering may be performed efficiently.

FIG. 6B is a block diagram a frame structure 650 of a probe response packet according to some embodiments. As discussed above with reference to FIG. 6A, the frame structure 650 may represent an Ethernet frame including, among other fields, a destination address 610, a source address 620, and an EtherType (e.g., Ethernet type 630). In simple probing scenarios (e.g., those not involving the return of additional information regarding the targeted node or nodes), generation of a probe response packet may merely involve swapping the destination address and source address of the probe packet.

In the context of the present example, effectively the same simple frame structure may be used by both sides (e.g., the probe source and the probe destination) to simplify the processing of probe and response packets. It is to be appreciated, the frame structure for probe packets may be modified to allow for inclusion of requests for additional information from the targeted node(s) or microservice(s)/application(s) running on the targeted node(s). Similarly, the frame structure for probe response packets may be modified to allow for the requested additional information to be returned within the probe response packets.

### Example Use Cases

Node availability monitoring is a common requirement in distributed systems and cloud clusters. For efficient operation of such cloud clusters, node failure should be handled in a timely manner. The sooner a failure is detected, the smaller the impact such failure may have on the operations of the cloud cluster. Given the flexibility and deterministic nature of the failure detection approach described herein, it is expected the approach may be used to help build more robust cloud systems.

The failure detection approach described herein may be used in a variety of types of distributed systems, including, but not limited to Kubernetes clusters, OpenStack clusters, and distributed key-value stores. For example, a Kubernetes orchestrator may make use of probing to monitor the status of each worker node. When a worker node fails, the orchestrator could detect the failure within a very short time and promptly migrate workloads running on the failed node to other healthy nodes to reduce the impact of the failure. Similarly, in the context of an etcd system, each follower could independently monitor the health of the leader and choose different period to avoid competition in new leader selection.

Depending on the particular implementation, building on the flexibility of the failure detection approach described herein, a monitor node (e.g., monitor node 210a) may monitor the availability of monitored nodes (e.g., monitored node 210b) with different frequencies, or even employ different frequency for different situations involving the same targeted node or nodes. Additionally or alternatively, the monitor node may adjust its probing interval to achieve improved performance and/or to reduce the amount of heartbeat traffic.

While the examples provided herein mainly focus on node failure detection, it is to be appreciated the approach can be extended to application failure detection. An example flow for application failure detection might be as follows:
1. Program B (to be monitored) is running on a monitored node (e.g., monitored node 210b). Program B periodically updates its status to a local HB agent (e.g., HB agent 215b).
2. When HB agent 215b receives a probe packet for Program B from a remote HB agent (e.g., HB agent 215a), it will check the status of Program B. If it doesn't receive a heartbeat from Program B at expected time, it will not respond to HB agent 215a. Then, HB Agent 215a may notify Program A (the monitor program) about the failure of Program B.

Building on the prior example, once HB agents are populated within a data center, they can use their own protocol to indicate the status of multiple of the applications running on a given platform. For example, when an explicit application-level heartbeat is to be sent, the HB agent of the monitor node may ask for and aggregate the status of all the application instances running on the monitored node as part of a single probe and response cycle, thereby having a greater impact on the reduction of the amount of heartbeat network traffic as the number of application instances is scaled up.

### Example Computer System

FIG. 7 is an example of a computer system 700 according to some embodiments. Computer system may itself represent a node of a distributed system (e.g., one of distributed systems 130 or 140) or a cluster of a container platform system or may host one or more nodes of the distributed system or the cluster. Notably, components of computer system 700 described herein are meant only to exemplify various possibilities. In no way should example computer system 700 limit the scope of the present disclosure. In the context of the present example, computer system 700 includes a bus 702 or other communication mechanism for communicating information, and a processing resource (e.g., one or more hardware processors 704) coupled with bus 702 for processing information.

Computer system 700 also includes a main memory 706, such as a random-access memory (RAM) or other dynamic storage device, coupled to bus 702 for storing information and instructions to be executed by processor 704. Main memory 706 also may be used for storing temporary variables or other intermediate information during execution of instructions to be executed by processor 704. Such instructions, when stored in non-transitory storage media accessible to processor 704, render computer system 700 into a special-purpose machine that is customized to perform the operations specified in the instructions.

Computer system 700 further includes a read only memory (ROM) 708 or other static storage device coupled to bus 702 for storing static information and instructions for processor 704. A storage device 710, e.g., a magnetic disk, optical disk or flash disk (made of flash memory chips), is provided and coupled to bus 702 for storing information and instructions.

Computer system 700 may be coupled via bus 702 to a display 712, e.g., a cathode ray tube (CRT), Liquid Crystal Display (LCD), Organic Light-Emitting Diode Display (OLED), Digital Light Processing Display (DLP) or the like, for displaying information to a computer user. An input device 714, including alphanumeric and other keys, is coupled to bus 702 for communicating information and command selections to processor 704. Another type of user input device is cursor control 716, such as a mouse, a trackball, a trackpad, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

Removable storage media 740 can be any kind of external storage media, including, but not limited to, hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM), USB flash drives and the like.

Computer system 700 may implement the techniques described herein using customized hard-wired logic, one or more ASICs or FPGAs, firmware or program logic which in combination with the computer system causes or programs computer system 700 to be a special-purpose machine. According to one embodiment, the techniques herein are performed by computer system 700 in response to processor 704 executing one or more sequences of one or more instructions contained in main memory 706. Such instructions may be read into main memory 706 from another storage medium, such as storage device 710. Execution of the sequences of instructions contained in main memory 706 causes processor 704 to perform the process steps described herein. In alternative embodiments, hard-wired circuitry may be used in place of or in combination with software instructions.

The term “storage media” as used herein refers to any non-transitory media that store data or instructions that cause a machine to operation in a specific fashion. Such storage media may comprise non-volatile media or volatile media. Non-volatile media includes, for example, optical, magnetic or flash disks, such as storage device 710. Volatile media includes dynamic memory, such as main memory 706. Common forms of storage media include, for example, a flexible disk, a hard disk, a solid-state drive, a magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 702. Transmission media can also take the form of acoustic or light waves, such as those generated during radio-wave and infra-red data communications.

Various forms of media may be involved in carrying one or more sequences of one or more instructions to processor 704 for execution. For example, the instructions may initially be carried on a magnetic disk or solid-state drive of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes interface circuitry 718 coupled to bus 702. The interface circuitry 718 may be implemented by hardware in accordance with any type of interface standard, such as an Ethernet interface, a universal serial bus (USB) interface, a Bluetooth® interface, a near field communication (NFC) interface, a PCI interface, and/or a PCIe interface. As such, interface 718 may couple the processing resource in communication with one or more discrete accelerators 705.

Interface 718 may also provide a two-way data communication coupling to a network link 720 that is connected to a local network 722. For example, interface 718 may be an integrated services digital network (ISDN) card, cable modem, satellite modem, or a modem to provide a data communication connection to a corresponding type of telephone line. As another example, interface 718 may be a local area network (LAN) card to provide a data communication connection to a compatible LAN. Wireless links may also be implemented. In any such implementation, interface 718 may send and receive electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the worldwide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718. The received code may be executed by processor 704 as it is received, or stored in storage device 710, or other non-volatile storage for later execution.

Many of the methods may be described in their most basic form, but processes can be added to or deleted from any of the methods and information can be added or subtracted from any of the described messages without departing from the basic scope of the present embodiments. It will be apparent to those skilled in the art that many further modifications and adaptations can be made. The particular embodiments are not provided to limit the concept but to illustrate it. The scope of the embodiments is not to be determined by the specific examples provided above but only by the claims below.

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to perform acts of the method, or of an apparatus or system for facilitating hybrid communication according to embodiments and examples described herein.

Some embodiments pertain to Example 1 that include a non-transitory machine-readable medium storing instructions, which when executed by a processing resource of a monitor node of a distributed system cause an agent running on the monitor node to: receive a request to send a probe packet to a monitored node of the distributed system; responsive to the request, cause the probe packet to be transmitted to the monitored node at a time specified by a time-based packet scheduling feature of a network interface associated with the monitor node; and responsive to expiration of a time period prior to receipt of a response packet to the probe packet, notify the process of a failure relating to the monitored node.

Example 2 includes the subject matter of Example 1, wherein the instructions further cause the agent to determine a round-trip time (RTT) for each of a plurality of probe packets based on a first time at which a given probe packet of the plurality of probe packets was transmitted from the monitor node and a second time at which a corresponding response packet to the given probe packet was received at the monitor node.

Example 3 includes the subject matter of Examples 1-2, wherein the instructions further cause the agent to establish the time period based on an average round-trip time (RTT) of a plurality of probe packets.

Example 4 includes the subject matter of Examples 1-3, wherein a peer agent runs within the monitored node, wherein the peer agent is interposed between a networking stack of a kernel of an operating system (OS) of the monitored node and a transmission media coupling the monitored node in communication with the monitor node, and wherein the response packet is generated by the peer agent.

Example 5 includes the subject matter of Examples 1-4, wherein the agent runs within a kernel framework that provides a programmable network data path in the kernel and wherein the kernel framework is attached via a driver of the network interface.

Example 6 includes the subject matter of Examples 1-5, wherein the network interface comprises a smart network interface card and wherein the agent runs within the smart network interface card.

Example 7 includes the subject matter of Examples 1-6, wherein the distributed system comprises a cluster, the monitor node is a primary node of the cluster, and the monitored node is a worker node of the cluster that is managed by the primary node.

Example 8 includes the subject matter of Examples 1-7, wherein the cluster comprises a cluster of a container management system and the process is associated with an orchestrator of the cluster.

Example 9 includes the subject matter of Examples 1-8, wherein the failure comprises a failure of the monitored node or a failure of a microservice or an application associated with the monitored node.

Some embodiments pertain to Example 10 that includes a distributed system comprising: a processing resource; and a machine-readable medium, coupled to the processing resource, having stored therein instructions, which when executed by the processing resource cause an agent running on a monitor node of the distributed system to: receive from a process running within a user space of an operating system (OS) of the monitor node, a request to send a probe packet to a monitored node of the distributed system, wherein the agent is interposed between a networking stack of a kernel of the OS and a transmission media coupling the monitor node in communication with the monitored node; responsive to the request, cause the probe packet to be transmitted to the monitored node via the transmission media at a time specified by the request by utilizing a time-based packet scheduling feature of a network interface associated with the monitor node; and responsive expiration of a time period prior to receipt of a response packet to the probe packet, notify the process of a failure relating to the monitored node.

Example 11 includes the subject matter of Example 10, wherein the instructions further cause the agent to establish the time period based on an average round-trip time (RTT) of a plurality of probe packets.

Example 12 includes the subject matter of Examples 10-11, wherein a peer agent runs within the monitored node, wherein the peer agent is interposed between a networking stack of a kernel of an OS of the monitored node and the transmission media, and wherein the response packet is generated by the peer agent.

Example 13 includes the subject matter of Examples 10-12, wherein the agent runs within a kernel framework that provides a programmable network data path in the kernel and wherein the kernel framework is attached via a driver of the network interface.

Example 14 includes the subject matter of Examples 10-13, wherein the network interface comprises a smart network interface card and wherein the agent runs within the smart network interface card.

Example 15 includes the subject matter of Examples 10-14, wherein the distributed system comprises a cluster, the monitor node is a primary node of the cluster, and the monitored node is a worker node of the cluster that is managed by the primary node.

Example 16 includes the subject matter of Examples 10-15, wherein the cluster comprises a cluster of a container management system and the process is associated with an orchestrator of the cluster.

Example 17 includes the subject matter of Examples 10-16, wherein the failure comprises a failure of the monitored node or a failure of a microservice or an application associated with the monitored node.

Example 18 includes the subject matter of Examples 10-17, wherein the probe packet solicits health information from the monitored node.

Some embodiments pertain to Example 19 that includes a method comprising: receiving, by an agent running on a monitor node of a distributed system from a process running within a user space of an operating system (OS) of the monitor node, a request to send a probe packet to a monitored node of the distributed system, wherein the agent is interposed between a networking stack of a kernel of the OS and a transmission media coupling the monitor node in communication with the monitored node; responsive to the request, causing, by the agent, the probe packet to be transmitted to the monitored node via the transmission media at a time specified by the request by utilizing a time-based packet scheduling feature of a network interface associated with the monitor node; and responsive to expiration of a time period prior to receipt of a response packet to the probe packet, notifying, by the agent, the process of a failure relating to the monitored node.

Example 20 includes the subject matter of Example 19, wherein the agent runs within a kernel framework that provides a programmable network data path in the kernel and wherein the kernel framework is attached via a driver of the network interface.

Example 21 includes the subject matter of Examples 19-20, wherein the network interface comprises a smart network interface card and wherein the agent runs within the smart network interface card.

Example 22 includes the subject matter of Examples 19-21, wherein the distributed system comprises a cluster, the monitor node is a primary node of the cluster, and the monitored node is a worker node of the cluster that is managed by the primary node.

Example 23 includes the subject matter of Examples 19-22, wherein the cluster comprises a cluster of a container management system and the process is associated with an orchestrator of the cluster.

Example 24 includes the subject matter of Examples 19-23, wherein the failure comprises a failure of the monitored node or a failure of a microservice or an application associated with the monitored node.

Some embodiments pertain to Example 25 that includes an apparatus that implements or performs a method of any of Examples 19-24.

Some embodiments pertain to Example 26 includes an apparatus comprising means for performing a method as claimed in any of Examples 19-24.

Some embodiments pertain to Example 27 that includes at least one machine-readable medium comprising a plurality of instructions, when executed on a computing device, implement or perform a method or realize an apparatus as described in any preceding Example.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

1-24. (canceled)

25. A non-transitory machine-readable medium storing instructions, which when executed by one or more processing resources of a monitor node of a distributed system cause an agent running on the monitor node to:
receive, from a process running on the monitor node, a request to send a probe packet to the monitored node;
after receipt of the request, cause the probe packet to be transmitted to the monitored node at a time specified by a time-based packet scheduling feature of a network interface associated with the monitor node; and
after expiration of a time period in which a response packet to the probe packet has not been received, notify the process of a failure relating to the monitored node.

26. The non-transitory machine-readable medium of claim 25, wherein the instructions further cause the agent to determine a round-trip time (RTT) for each of a plurality of probe packets based on a first time at which a given probe packet of the plurality of probe packets was transmitted from the monitor node and a second time at which a corresponding response packet to the given probe packet was received at the monitor node.

27. The non-transitory machine-readable medium of claim 25, wherein the instructions further cause the agent to establish the time period based on an average round-trip time (RTT) of a plurality of probe packets.

28. The non-transitory machine-readable medium of claim 25, wherein a peer agent runs within the monitored node, wherein the peer agent is interposed between a networking stack of a kernel of an operating system (OS) of the monitored node and a transmission media coupling the monitored node in communication with the monitor node, and wherein the response packet is generated by the peer agent.

29. The non-transitory machine-readable medium of claim 25, wherein the agent runs within a kernel framework that provides a programmable network data path in the kernel and wherein the kernel framework is attached via a driver of the network interface.

30. The non-transitory machine-readable medium of claim 25, wherein the network interface comprises a smart network interface card and wherein the agent runs within the smart network interface card.

31. The non-transitory machine-readable medium of claim 25, wherein the distributed system comprises a cluster, the monitor node comprises a primary node of the cluster, and the monitored node comprises a worker node of the cluster that is managed by the primary node.

32. The non-transitory machine-readable medium of claim 31, wherein the cluster comprises a cluster of a container management system and the process is associated with an orchestrator of the cluster of the container management system.

33. The non-transitory machine-readable medium of claim 25, wherein the failure comprises a failure of the monitored node or a failure of a microservice or an application associated with the monitored node.

34. A distributed system comprising:
one or more processing resources; and
a machine-readable medium, coupled to the one or more processing resources, having stored therein instructions, which when executed by the one or more processing resources cause an agent running on a monitor node of the distributed system to:
receive from a process running within a user space of an operating system (OS) of the monitor node, a request to send a probe packet to a monitored node of the distributed system, wherein the agent is interposed between a networking stack of a kernel of the OS and a transmission media coupling the monitor node in communication with the monitored node;
responsive to the request, cause the probe packet to be transmitted to the monitored node via the transmission media at a time specified by the request by utilizing a time-based packet scheduling feature of a network interface associated with the monitor node; and
after expiration of a time period in which a response packet to the probe packet has not been received, notify the process of a failure relating to the monitored node.

35. The distributed system of claim 34, wherein the instructions further cause the agent to establish the time period based on an average round-trip time (RTT) of a plurality of probe packets.

36. The distributed system of claim 34, wherein the agent runs within a kernel framework that provides a programmable network data path in the kernel and wherein the kernel framework is attached via a driver of the network interface.

37. The distributed system of claim 34, wherein the network interface comprises a smart network interface card and wherein the agent runs within the smart network interface card.

38. The distributed system of claim 34, wherein the distributed system comprises a cluster, the monitor node is a primary node of the cluster, and the monitored node is a worker node of the cluster that is managed by the primary node.

39. The distributed system of claim 34, wherein the probe packet solicits health information from the monitored node.

40. A method comprising:
receiving, by an agent running on a monitor node of a distributed system from a process running within a user space of an operating system (OS) of the monitor node, a request to send a probe packet to a monitored node of the distributed system, wherein the agent is interposed between a networking stack of a kernel of the OS and a transmission media coupling the monitor node in communication with the monitored node;
responsive to the request, causing, by the agent, the probe packet to be transmitted to the monitored node via the transmission media at a time specified by the request by utilizing a time-based packet scheduling feature of a network interface associated with the monitor node; and
after expiration of a time period in which a response packet to the probe packet has not been received, notifying, by the agent, the process of a failure relating to the monitored node.

41. The method of claim 40, wherein the agent runs within a kernel framework that provides a programmable network data path in the kernel and wherein the kernel framework is attached via a driver of the network interface.

42. The method of claim 40, wherein the network interface comprises a smart network interface card and wherein the agent runs within the smart network interface card.

43. The method of claim 40, wherein the distributed system comprises a cluster, the monitor node is a primary node of the cluster, and the monitored node is a worker node of the cluster that is managed by the primary node.

44. The method of claim 40, wherein the failure comprises a failure of the monitored node or a failure of a microservice or an application associated with the monitored node.
